(19) United States
(12) Patent Application Publication
(10) Pub. No.: US 2003/0184611 A1
(43) Pub. Date: Oct. 2, 2003

(54) Microarray printing device

(76) Inventors: Hsien-Nan Kuo, Kaohsiung City (TW); Shui-Chi Yen, Kaohsiung Hsien (TW); Chun-Chieh Wang, Kaohsiung City (TW)

Correspondence Address: FULWIDER PATTON LEE & UTECHT, LLP, HOWARD HUGHES CENTER, 6060 CENTER DRIVE, TENTH FLOOR, LOS ANGELES, CA, 90045, US

(21) Appl. No.: 10/113,525

(22) Filed: Mar. 27, 2002

(51) Int. Cl. B41J 2/015

(52) U.S. Cl. 347/20; 347/54; 400/124.14

(57) ABSTRACT

A microarray printing device includes an elongate holder having a plurality of receiving slots, and printing pins. Each printing pin extends through and is linearly movable in a corresponding receiving slot in the holder, and has head and tip portions. The tip portion has a tapered surface, a tip end face, a plurality of capillary channels that extend axially on the tapered surface from the tip end face, and a plurality of passages formed on the tapered surface for collecting liquid and connected respectively to the channels opposite to the tip end face.

### BACKGROUND OF THE INVENTION

1. Field of the Invention

The invention relates to a microarray printing device, more particularly to a microarray printing device for printing a microarray of biochemical substance in a biochip.

2. Description of the Related Art

Referring to FIG. 1, a conventional microarray printing device 6 is shown to comprise a holder 61 and a plurality of printing pins 62 mounted on the holder 61 and formed with split tips 622. The holder 61 is processed to have an upper surface 611 formed with a plurality of parallel guide grooves 612 and a plurality of receiving slots 616 extending downwardly from the guide grooves 612 to a lower surface 615 of the holder 61. Each of the printing pins 62 has a head portion 621 and a shank portion 623. The head portion 621 has a bottom surface that abuts against a groove bottom of the corresponding groove 612. The shank portion 623 extends slidably through the corresponding slot 616.

In use, the holder 61 is activated to linearly move the pins 62 into proximity with a printing substrate 100 so as to start printing. The pins 62 are immediately removed from the printing substrate 100 after the tips 622 have touched the latter to prevent excessive time of contact which will result in excessive release of liquid (generally, volume of one liquid drop is 2 pL˜2 nL) The printing pins 62 are closely arranged in a rectangular pattern so as to achieve the purpose of microarray printing.

However, since the guide grooves 612 are individually processed, their depths are not actually the same. As such, the printing pins 62 are not uniform in height and are not lying on the same planar surface. Thus, some tips 622 of the printing pins 62 are in excessive contact with the printing substrate 100 during the printing process, thereby lowering the printing quality. Furthermore, since the shank portion 623 of each printing pin 62 rubs against the surrounding wall 614 that defines the corresponding slot 616 when the former slides upward and downward along the corresponding slot 616 during the printing process, powdery shavings are produced and are stuck in a gap between the shank portion 623 and the surrounding wall 614, thereby resulting in air blockage, and thereby disabling functionality of the printing pins 62.

Another conventional microarray printing device (not shown) found in the market includes a hollow holder and a plurality of capillary tube-like printing pins hung on a top face within the holder by spring units. Since the cross-sections of the capillary tube-like printing pins are generally small, when the tips of the pins contact the substrate, the tips are subjected to a pressure produced not only by the weight of the shank portions, but also by the biasing forces of the spring units, such that the tips are easily broken.

### SUMMARY OF THE INVENTION

Therefore, the main object of the present invention is to provide a microarray printing device that is capable of overcoming the aforementioned drawbacks of the prior art.

According to this invention, a microarray printing device comprises an elongate holder having a plurality of receiving slots, and a plurality of printing pins. Each of the printing pins extends through and is linearly movable in a respective one of the receiving slots in the holder, and has a head portion, and a tip portion opposite to the head portion. The tip portion has a tapered surface, a tip end face at an end of the tapered surface, a plurality of capillary channels that extend axially and upwardly on the tapered surface from the tip end face, and a plurality of passages formed on the tapered surface for collecting liquid and connected respectively to the channels opposite to the tip end face. The passages are wider and deeper than the channels.

### BRIEF DESCRIPTION OF THE DRAWINGS

Other features and advantages of the present invention will become apparent in the following detailed description of the preferred embodiment with reference to the accompanying drawings, of which:

FIG. 1 is a sectional view of a conventional microarray printing device, illustrating its position above a printing substrate;

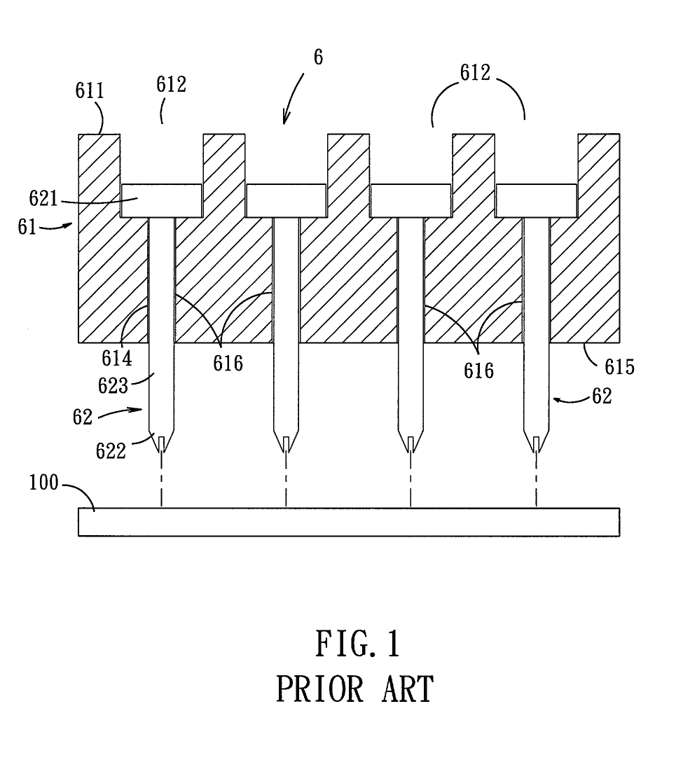

FIG. 2 is a perspective view of the preferred embodiment of a microarray printing device according to the present invention;

FIG. 3 is a perspective view of the printing pin of the preferred embodiment; and

FIG. 4 is an enlarged fragmentary perspective view showing a tip portion of the printing pin of the preferred embodiment.

### DETAILED DESCRIPTION OF THE PREFERRED EMBODIMENT

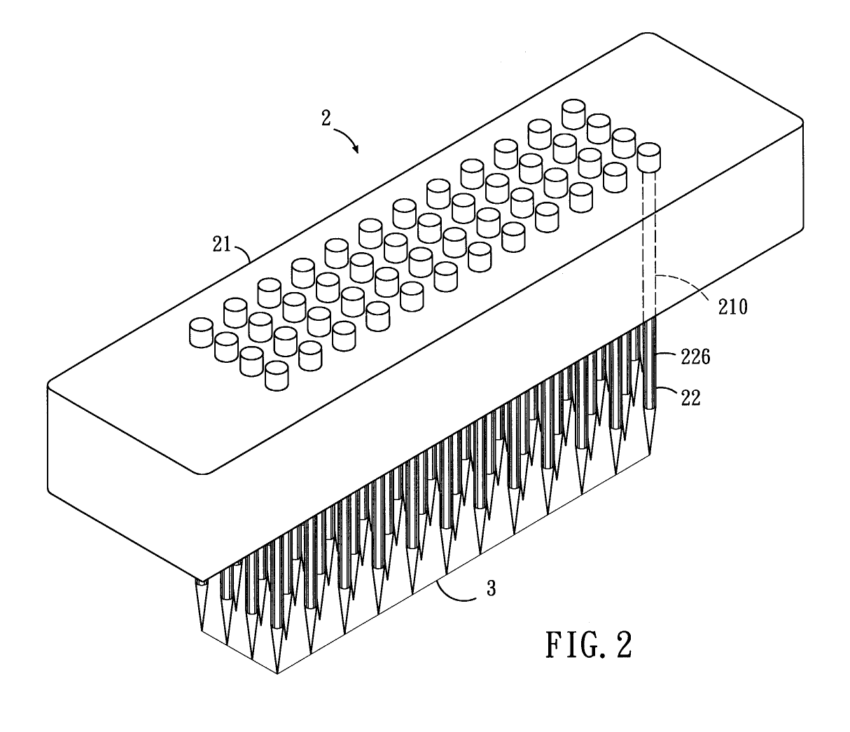

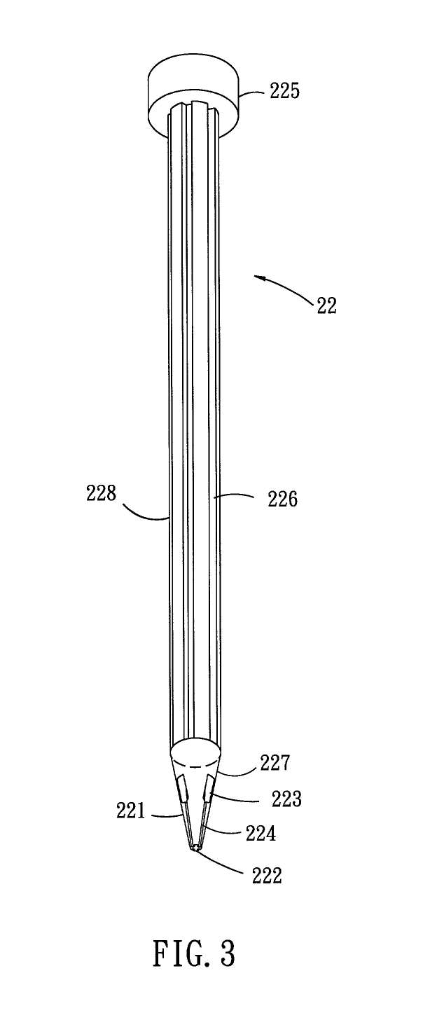

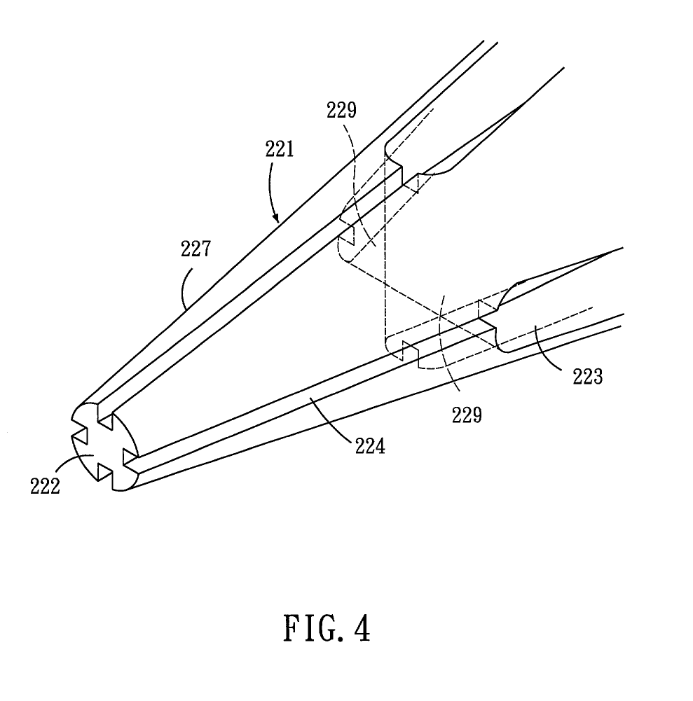

Referring to FIGS. 2 and 4, the preferred embodiment of a microarray printing device 2 according to the present invention is shown to comprise an elongate holder 21 having a plurality of receiving slots 210, and a plurality of printing pins 22. Each of the printing pins 22 extends through and is linearly movable in a respective one of the receiving slots 210 in the holder 21, and has a head portion 225, a tip portion 221 opposite to the head portion 225, and a shank portion 228 disposed between the head and tip portions 225, 221. The shank portion 228 has a surface formed with a plurality of longitudinal flutes 226 extending from the head portion 225 to the tip portion 221, as best shown in FIG. 3.

The tip portion 221 of each printing pin 22 in this embodiment is substantially conical. Alternatively, the tip portion 221 may be a quadrilateral pyramid or a polyhedron. The tip portion 221 has a tapered surface 227, a tip end face 222 at an end of the tapered surface 227, a plurality of capillary channels 224 that extend axially on the tapered surface 227 from the tip end face 222 in a direction away from the tip end face 222, and a plurality of passages 223 formed on the tapered surface 227 for collecting liquid and connected respectively to the channels 224 opposite to the tip end face 222, as best illustrated in FIG. 4. The passages 223 are wider and deeper than the capillary channels 224, and extend from the tapered surface 227 into the tip portion 221. The passages 223 may be formed by providing the tip portion 221 with two intersecting diametral through holes 229, each of which has two opposite ends opening at the tapered surface 227 to form a pair of opposite passages 223. As such, the passages 223 communicate with each other inside the tip portion 221.

Sometimes, printing is carried out by using a single printing pin 22. Liquid is collected and stored in the passages 223 of the tip portion 221 after the pin 22 is dipped in the liquid. Due to capillary action, liquid is drawn from the passages 223 through the capillary channels 224 to the tip end face 222 of the tip portion 221, and is formed as a liquid drop suspended on the tip end face 222. The liquid drop is then transferred onto a surface of a printing substrate (not shown) to accomplish the printing process.

Since the tip end face 222 of each printing pin 22 has a solid core and is not split, as best shown in FIG. 4, and since the liquid drop can be suspended on the tip end face 222 due to the capillary channels 224, the tip end face 222 need not contact the substrate, thereby reducing knocking force of each printing pin 22. As such, the tip end face 222 of each printing pin 22 is prevented from deforming and a good printing effect is ensured.

Referring back to FIG. 2, for a microarray printing process, the printing pins 22 move linearly within the respective slots 210 in the holder 2. Because the flutes 226 are provided in the shank portion 228, powdery shavings produced due to friction between the shank portion 228 of each printing pin 22 and a surrounding wall that defines the corresponding one of the slots 210 in the holder 2 are discharged via the flutes 226 in the shank portion 228, thereby permitting smooth sliding movement of the printing pins 22 within the slots 210 in the holder 2, and thereby permitting air ventilation in the holder 2.

At the same time, the head portion 225 of each printing pin 22 has a bottom shoulder face that abuts against a top face of the holder 2 so as to prevent each printing pin 22 from falling off the holder 2. The top face of the holder 2 is then used as a reference surface to support the head portions 225 of the printing pins 22 and to control the distance from the bottom shoulder face of the head portion 225 to the tip end face 222 of the tip portion 221 such that the tip end faces 222 of all printing pins 22 can be aligned in a planar surface 3. As such, the tip end faces 222 of the printing pins 22 contact the substrate (not shown) at the same time, thereby achieving fast and uniform printing.

The capillary channels 224 described above are formed by an electric discharge machining process using an electrode disc so that the capillary channels 224 in each printing pin 22 can be accurately formed. Alternatively, a casting process maybe employed to mass produce the tip portions 221 of the printing pins 22 with the same accurate result so as to lower the production cost. Since the electric discharge machining process and the casting process are well known in the art, a detailed description thereof will be dispensed with herein for the sake of brevity.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A microarray printing device comprising:
an elongate holder having a plurality of receiving slots; and
a plurality of printing pins, each of which extends through and is linearly movable in a respective one of said receiving slots in said holder, each of said printing pins having a head portion, and a tip portion opposite to said head portion, said tip portion having a tapered surface, a tip end face at an end of said tapered surface, a plurality of capillary channels that extend axially on said tapered surface from said tip end face in a direction away from said tip end face, and a plurality of passages formed on said tapered surface for collecting liquid and connected respectively to said channels opposite to said tip end face, said passages being wider and deeper than said channels.

2. The microarray printing device as claimed in claim 1, wherein said passages extend from said tapered surface into said tip portion and communicate with each other inside said tip portion.

3. The microarray printing device as claimed in claim 2, wherein each of said passages at one side of said tapered surface is diametrically opposite to one of said passages at the other opposite side of said tapered surface.

4. The microarray printing device as claimed in claim 1, wherein each of said printing pins further includes a shank portion disposed between said head and tip portions, said shank portion having a surface formed with a plurality of longitudinal flutes extending from said head portion to said tip portion.

5. The microarray printing device as claimed in claim 1, wherein said tip portion of each of said printing pins is substantially conical.

6. The microarray printing device as claimed in claim 1, wherein said passages are formed by an electric discharge machining process.

7. The microarray printing device as claimed in claim 1, wherein said tip portion of each of said printing pins is formed by a casting process.
